(19) United States
(12) Patent Application Publication
(10) Pub. No.: US 2007/0103799 A1
(43) Pub. Date: May 10, 2007

(54) Brightness Enhancement Print Medium and Brightness Enhanced Print with Optical Structures

(75) Inventors: Whe-Yi Chiang, Hsinchu City (TW); Ta-Ching Pong, Hsinchu city (TW)

Correspondence Address: WPAT, PC, 7225 BEVERLY ST., ANNANDALE, VA, 22003, US

(73) Assignee: LENTICS CORPORATION, Hsinchu city (TW)

(21) Appl. No.: 11/552,127

(22) Filed: Oct. 23, 2006

(30) Foreign Application Priority Data
Nov. 9, 2005 (TW) 94139217

(51) Int. Cl. G02B 5/04

(52) U.S. Cl. 359/834

(57) ABSTRACT

The invention provides a brightness enhancement print medium and a brightness enhanced print with optical structures to create a print showing lenticular effects, such as 3D, flip, and animation effects with high image quality and excellent visibility. The brightness enhanced print with optical structures according to the invention comprises a substrate, an optical layer, a print layer, and a reflective layer.

### BACKGROUND OF THE INVENTION

1. Field of the Invention

The present invention is generally related to a brightness enhancement print medium and a brightness enhanced print with optical structures, and more particularly to a brightness enhancement print medium and a brightness enhanced print with lenticular lenses to create 2D or 3D effects.

2. Description of the Prior Art

There are various different forms of lenticular effects: 3D, flip, animation, morph and zoom. For example, as shown in FIGS. 1A and 1B the method to create lenticular effects, such as flip effect, is to have A and B image files divided into stripes and interlaced together into an image file (FIG. 1A), to align the interlaced image printout with the lenticular lens sheet or directly print the interlaced image on the lenticular lens sheet (FIG. 1B). The different images A and B can be delivered to each eye from different viewing angle to create flip effect.

In general, prints showing lenticular effects from directly printing on the flat side of the lenticular lens are formed as photos, magnets, cards, calendars, business cards, membership cards, posters, etc. In order to have a distinguishable and clear view of images, the print is usually backed with a white layer or a reflective layer. However, the image for showing lenticular effects still needs special design, such as selecting images with bright colors, in order to show good impression.

On the other hand, prints showing lenticular effects by adhering image-printed papers to lenticular lenses via optically clear double-sided tapes cannot use reflective films to increase the visibility. Therefore, in order to have good image quality and excellent visibility, these prints have to be specially designed to have images with bright colors. It is thus difficult to produce artistically valuable prints with lenticular effects.

### SUMMARY OF THE INVENTION

In light of the above-mentioned matter, the present invention provides a brightness enhancement print medium and a brightness enhanced print with optical structures to create a print showing lenticular effects, such as 3D, flip, and animation effects with high image quality and excellent visibility.

One object of the present invention is to provide a brightness enhanced print with optical structures, comprising: a substrate, an optical layer, a print layer, and a reflective layer. The substrate has a first surface and a second surface. The optical layer is provided on the first surface of the substrate and has a plurality of linear lenticular lenses. The print layer is provided on the second surface of the substrate and the reflective layer is provided on the print layer. The reflective layer has a texture surface and a planar surface. The planar surface is contacted with the print layer and the texture surface has a plurality of optical elements to have total internal reflection for light incident on the optical elements.

In a preferred embodiment, the print layer can be formed directly on the first surface by ink. In another preferred embodiment, the print layer can be formed by printing images on a transparent medium and then laminating on the first surface of the substrate through an adhesive material. The adhesive material can be hot-melt glue or pressure sensitive glue.

In addition, the optical elements on the texture surface are retroreflective. The optical elements on the texture surface are a prism array or a matrix of 4-side prism. In a preferred embodiment, the optical elements on the texture surface are a prism array and each prism has two curved surfaces extending out of the texture surface. In a preferred embodiment, the linear lenticular lenses are perpendicular to the prisms.

Another object of the present invention is to provide brightness enhancement print medium, comprising: a substrate, an ink-receptive layer, and a reflective layer. The substrate has a first surface and a second surface. The ink-receptive layer is provided on the first surface of the substrate for use in a printing process. The reflective layer is provided on the second surface of the substrate. In addition, a plurality of optical elements are provided on the reflective layer.

The optical elements on the reflective layer are retroreflective. The optical elements on the reflective layer are a prism array or a matrix of 4-side prism. In a preferred embodiment, the optical elements on the reflective layer are a prism array and each prism has two curved surfaces extending out of the second surface. In a preferred embodiment, the linear lenticular lenses are perpendicular to the prisms.

Therefore, the brightness enhanced print according to the present invention produces a high quality picture with 2D, 3D, or animation effect. Besides, the brightness enhancement print medium according to the present invention can be utilized together with the lenticular sheet to create an artistic print with 2D, 3D, or animation effect.

### BRIEF DESCRIPTION OF THE DRAWINGS

FIGS. 1A and 1B show the method to create lenticular effects;

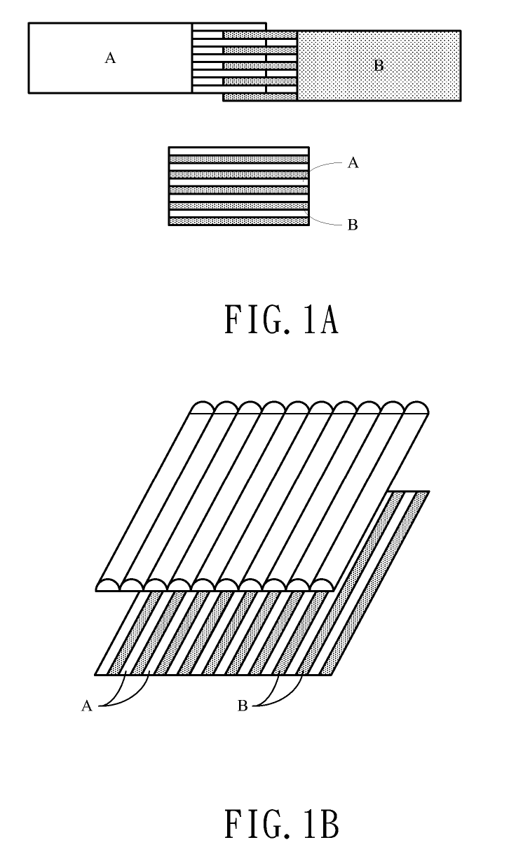

FIG. 2 shows the schematic structure of a brightness enhanced print with optical structure according to the first embodiment of the present invention; and

FIG. 3 shows the schematic structure of a brightness enhancement print medium according to the fifth embodiment of the present invention.

### DESCRIPTION OF THE PREFERRED EMBODIMENTS

What is probed into the invention is a brightness enhancement print medium and a brightness enhanced print with optical structures. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

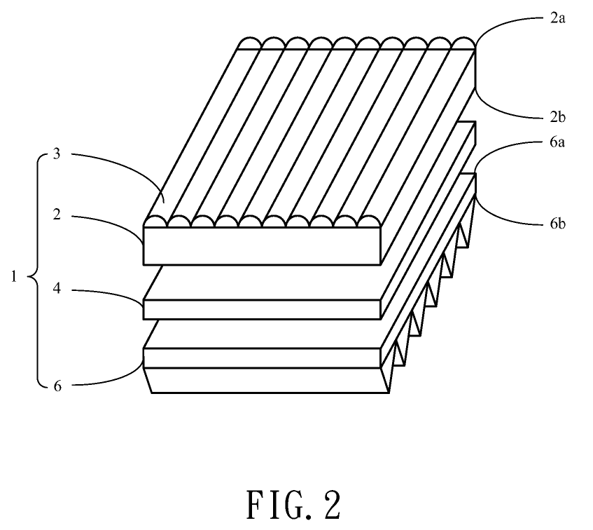

The first embodiment of the present invention discloses a brightness enhanced print 1 with optical structures, as shown in FIG. 2. The print 1 comprises a substrate 2, an optical layer 3, a print layer 4 and a reflective layer 6. The substrate 2 has a first surface 2a and a second surface 2b. The optical layer 3 is provided on the first surface 2a and has a plurality of linear lenticular lenses. The substrate 2 is a plastic sheet and the optical layer 3 is formed on the substrate 2 by hot pressing via an embossing roller. The surface of the embossing roller is formed with the lenticular pattern. The print layer 4 is provided on the second surface 2b by printing an interlaced image via an offset printer. The reflective layer 6 is provided on the print layer. The reflective layer 6 has a texture surface 6a and a planar surface 6b. The planar surface 6b is contacted with the print layer 4 through an adhesive material. The texture surface 6a has a prism array to have total internal reflection for light incident on the linear prisms.

The prism array comprises a plurality of linear prisms. The linear prism has two surfaces extending out of the texture surface. The angle between the two surfaces of the linear prism extending out of the texture surface is about 90˜100 degrees. The angle between the texture surface and the surface of the linear prism extending out of the texture surface is about 45˜40 degrees. The pitch of the prisms is about 40˜50 μm. The two surfaces of the linear prism extending out of the texture surface may be slightly curved in order to compensate the focal point of the lenticular lens for sharpening the printed image on the print layer 4. By the total internal reflection via the prism array, the visibility of the image on the print can be increased. The prism array is formed by coating and curing UV curable resin on a carrier film via a mold. The carrier film can be a PET (polyethylene terephthalate) or PMMA (polymethyl methacrylate) film. In addition, the linear prisms are perpendicular to the lenticular lenses.

In general, the conventional print with lenticular effect comprises a plastic sheet, one surface of which is formed with lenticular lens array and the other surface of which is printed with an interlaced image. The plastic sheet usually is backed with a white reflective sheet adhered to the surface with the interlaced image. The white reflective sheet is to enhance the visibility of the image. However, the reflection characteristic of the conventional reflective sheet is non-directional and diffusive. The conventional reflective sheet reflects light toward every direction. Moreover, a print with lenticular lenses generally has a smaller viewing angle and thus the conventional reflective sheet is not effective. On the contrary, the print according to the invention utilizes total internal reflection and has more effective reflection, compared to the conventional one.

The second embodiment of the present invention discloses a brightness enhanced print that is the same as the first embodiment except that the print layer 4 is formed on the planar surface 6b of the reflective layer 6 and is contacted with the second surface 2b of the substrate 2 via an adhesive material. In this embodiment, the print layer 4 is formed by printing an interlaced image on the planar surface 6b of the reflective layer 6 via an ink jet printer.

The third embodiment of the invention discloses a brightness enhanced print that is the same as the first embodiment except that the optical elements are 4-side prisms that form a matrix.

The fourth embodiment of the invention discloses a brightness enhanced print that is the same as the first embodiment except that the print layer is formed by printing the image on a transparent medium and then laminating on the second surface of the substrate through an adhesive material.

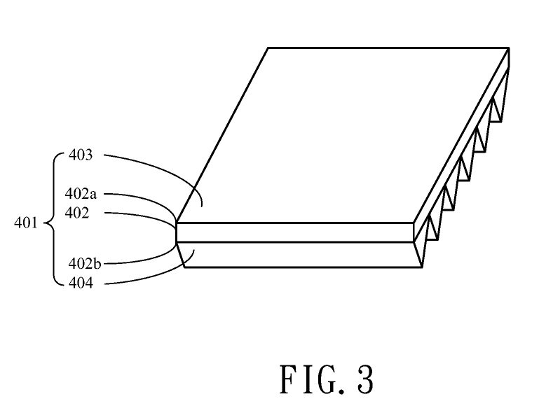

The fifth embodiment of the invention discloses a brightness enhanced print medium 401. As shown in FIG. 3, the brightness enhanced print medium 401 comprises a substrate 402, an ink-receptive layer 403, and a reflective layer 404. The substrate 402 has a first surface 402a and a second surface 402b. The ink-receptive layer 403 is provided on the first surface 402a for use in a printing process. The reflective layer 404 is provided on the second surface 402b. In addition, a plurality of optical elements are provided on the reflective layer 404. The substrate 402 is a PET film. The ink-receptive layer 403 is for receiving water-soluble color ink. The ink-receptive layer can be any conventional ink-receptive layer as long as it meets the requirements of readily wetting, no ink trailing, short ink-drying time, and a minimum of haze. One class of such material for the typical ink-receptive layer is vinyl pyrrolidone polymers, usually together with surfactants. For example, U.S. Pat. No. 5,139,867 discloses another type of the ink-receptive layer. The reflective layer 404 has the same characteristic as the reflective layer 6 in the first to fourth embodiments.

To sum up, the present invention discloses a brightness enhancement print medium and a brightness enhanced print with optical structures to create a print showing lenticular effects, such as 3D, flip, and animation effects with high image quality and excellent visibility.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A brightness enhanced print with optical structures, comprising:
a substrate having a first surface and a second surface;
an optical layer provided on the first surface of the substrate wherein the optical layer has a plurality of linear lenticular lenses;
a print layer provided on the second surface of the substrate; and,
a reflective layer provided on the print layer wherein the reflective layer has a texture surface and a planar surface, the planar surface is contacted with the print layer, and the texture surface has a plurality of optical elements to have total internal reflection for light incident on the optical elements.

2. The brightness enhanced print with optical structures according to claim 1, wherein the optical elements on the texture surface are retroreflective.

3. The brightness enhanced print with optical structures according to claim 1, wherein the optical elements on the texture surface are selected from a group consisting of the following: a prism array and a matrix of 4-side prism.

4. The brightness enhanced print with optical structures according to claim 1, wherein the print layer is formed directly on the first surface by ink.

5. The brightness enhanced print with optical structures according to claim 1, wherein the print layer is formed by printing images on a transparent medium and then laminating on the second surface of the substrate through an adhesive material.

6. The brightness enhanced print with optical structures according to claim 1, wherein the optical elements on the texture surface are a prism array and each prism has two curved surfaces extending out of the texture surface.

7. The brightness enhanced print with optical structures according to claim 6, wherein the linear lenticular lenses are perpendicular to the prisms.

8. The brightness enhanced print with optical structures according to claim 1, wherein the planar surface of the reflective layer is laminated on the print layer through an adhesive material.

9. The brightness enhanced print with optical structures according to claim 1, wherein the print layer is formed by printing images on the planar surface of the reflective layer by inks and the print layer is laminated on the optical layer by an adhesive material.

10. A brightness enhancement print medium, comprising:
a substrate having a first surface and a second surface;
a ink-receptive layer provided on the first surface of the substrate for use in a printing process;
a reflective layer provided on the second surface of the substrate wherein a plurality of optical elements are provided on the reflective layer.

11. The brightness enhanced print medium according to claim 10, wherein the optical elements are retroreflective.

12. The brightness enhancement print medium according to claim 10, wherein the optical elements are selected from a group consisting of the following: a prism array and a matrix of 4-side prism.

13. The brightness enhanced print medium according to claim 10, wherein the optical elements are a prism array and each prism has two curved surfaces extending out of the second surface.

14. The brightness enhancement print medium according to claim 10, wherein liquid ink drops are applied on the ink-receptive layer in the printing process to provide a high quality image.

15. The brightness enhancement print medium according to claim 10, wherein the ink-receptive layer are transparent.
